(19) United States
(12) Patent Application Publication
(10) Pub. No.: US 2006/0215788 A1
(43) Pub. Date: Sep. 28, 2006

(54) Frequency conversion for multi-channels

(76) Inventor: Akira Nara, Tokyo (JP)

Correspondence Address: TEKTRONIX, INC., P.O. BOX 500, M/S 50-LAW, BEAVERTON, OR, 97077, US

(21) Appl. No.: 11/388,472

(22) Filed: Mar. 24, 2006

(30) Foreign Application Priority Data
Mar. 25, 2005 (JP) 2005-089333

(51) Int. Cl. H04L 27/00

(52) U.S. Cl. 375/324

(57) ABSTRACT

A frequency converter is provided for combining multiple inputs into a single frequency conversion path. A first frequency conversion stage 50 has first and second frequency conversion paths 501 and 502 that receive first and second input signals to produce first and second IF signals respectively. A combiner 19 sums up the first and second IF signals to provide it as one signal to the next frequency conversion stages 60 and 70. Oscillation frequencies of local oscillators 141 and 142 in the paths 501 and 502 are controlled to have a frequency difference FD between them so that the center frequencies of the first and second IF signals have the frequency difference FD between them. The output of the combiner 19 includes components of multi-channels but processed by the same circuits.

### BACKGROUND OF THE INVENTION

The present invention relates to a frequency conversion that is especially suitable for converting frequencies of a plurality of input signals.

A conventional signal analyzer for frequency domain, typically spectrum analyzer, has one input channel because frequency conversion is complicated. FIG. 1 is a block diagram of an example of a frequency converter of a conventional signal analyzer. An input amplifier 10 receives an input signal that is provided to a frequency converter having a plurality of frequency conversion stages 50, 60 and 70, which converts it into a lower frequency signal, such as an intermediate frequency(IF) signal.

Operations of the frequency conversion stages are basically the same though the processing frequencies are different. By way of example, the first frequency conversion (down conversion) stage 50 is described below. A mixer 12 multiplies the input signal by a signal of a predetermined frequency from a local oscillator (Lo1) 14. A band pass filter (BPF) 16 preferably passes only desired frequencies of the output signal from the mixer 12, which is provided to the next frequency conversion stage 60 via an amplifier 18. Similarly, an amplifier 26 within conversion stage 60 may provide an output signal to a subsequent frequency conversion stage 70 as shown. As shown, an analog to digital converter (ADC) 36 converts the output of the frequency conversion stage 70 into a digital signal that is separated into I (In-phase) and Q (Quadrature) components by a digital IQ splitter 46. The digital IQ splitter 46 may be implemented by DSP (digital signal processor) and produces digital sine and cosine signals that are multiplied by the digital signal from the ADC 36 to produce the digital I and Q components by calculation. The digital IQ components are used for constellation display, etc., to analyze the input signal.

By the way, if a signal analyzer could have a plurality of input channels, it would allow the following analyses and then have many advantages. For example, a wireless LAN technology “MIMO (Multiple Input Multiple Output)” uses a plurality of antennas at both transmitter and receiver to get faster wireless communication speed and the above signal analyzer could provide correlation analysis between the signal paths. In addition, it could also measure a plurality of signals of which frequencies are apart each other, such as a simultaneous analysis of uplink and downlink of communication.

U.S. patent publication No. 20003/0063695 discloses an invention that receives a plurality of input signals to convert the frequencies, of which FIG. 2 shows that the invention receives a plurality of input signals at a plurality of antennas, and the respective down converters convert the frequencies and the respective analog to digital converters convert them into digital data. However, the independent multiple conversion paths lead to high cost and it is difficult to match or align the characteristics between the paths.

U.S. Pat. No. 6,060,878 also discloses an invention with independent frequency conversion paths that convert frequencies of a plurality of input signals, and has the same problem as described above.

As described above, independent frequency converters for multiple input channels bring high cost and it is very difficult to match characteristics between the paths. Besides, the frequency converters would get out of synchronization because of delay difference between them.

Therefore what is desired is to convert frequencies of a plurality of input signals with keeping good synchronization and matched transfer characteristics between them.

### SUMMARY OF THE INVENTION

Embodiments of he present invention relate to frequency converters that receive a plurality of input signals, and utilize a plurality of down conversion stages to convert their frequencies. A first frequency conversion stage has a plurality of frequency conversion paths and a combiner. The frequency conversion paths receive a plurality of input signals and convert them into the respective intermediate frequency (IF) signals. The combiner combines the IF signals into a single IF signal and provides it to subsequent frequency conversion stages following the first frequency conversion stage. The first frequency conversion stage controls a frequency difference between the center frequencies of the intermediate frequencies. The frequency difference may be a predetermined value.

The frequency converter according to embodiments of the present invention may have IQ splitters that produce IQ signal pairs that are derived from the output IF signal of the frequency conversion stages and corresponds to the respective input signals. The quadrature oscillators of the IQ splitters are controlled to have a predetermined frequency difference between them wherein the quadrature oscillators can be virtual blocks implemented in DSP.

According to embodiments of the present frequency converter, although the first frequency conversion stage has a plurality of frequency conversion paths, outputs of the plurality of frequency paths are summed while maintaining the frequency difference between them to combine the multi-channel signals into one unified signal. Therefore, the unified signal is processed by the same subsequent frequency conversion stages, which leads to a lower cost and reduces timing and transmission differences between the channels. If a signal analyzer, such as a spectrum analyzer, adopts the present invention, it can achieve synchronization analysis between input signals at low cost.

Any objects, advantages and other novel features of the present invention will be apparent from the following detailed description when read in conjunction with the appended claims and attached drawings.

### BRIEF DESCRIPTION OF THE DRAWINGS

FIG. 1 (Prior Art) is a block diagram of an example of a conventional signal analyzer.

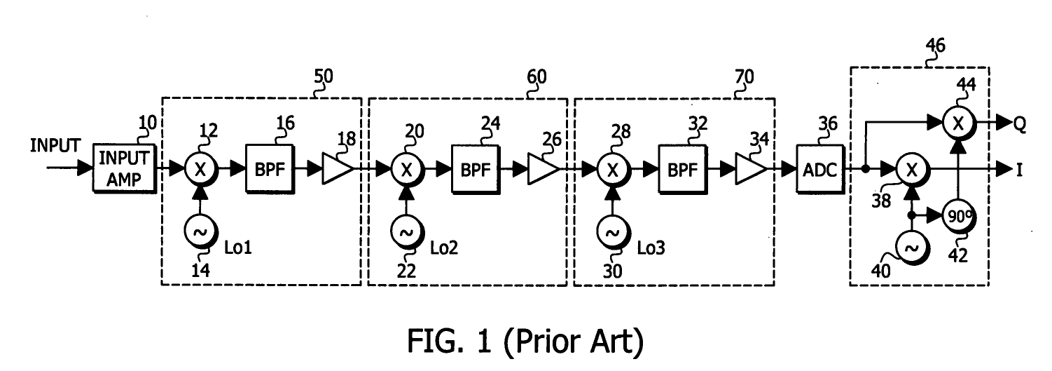

FIG. 2 is a block diagram of a preferred embodiment of a frequency converter according to the present invention.

FIG. 3 is graphs showing relationship between BPFs in FIG. 2 and intermediate frequencies.

### DETAILED DESCRIPTION OF THE INVENTION

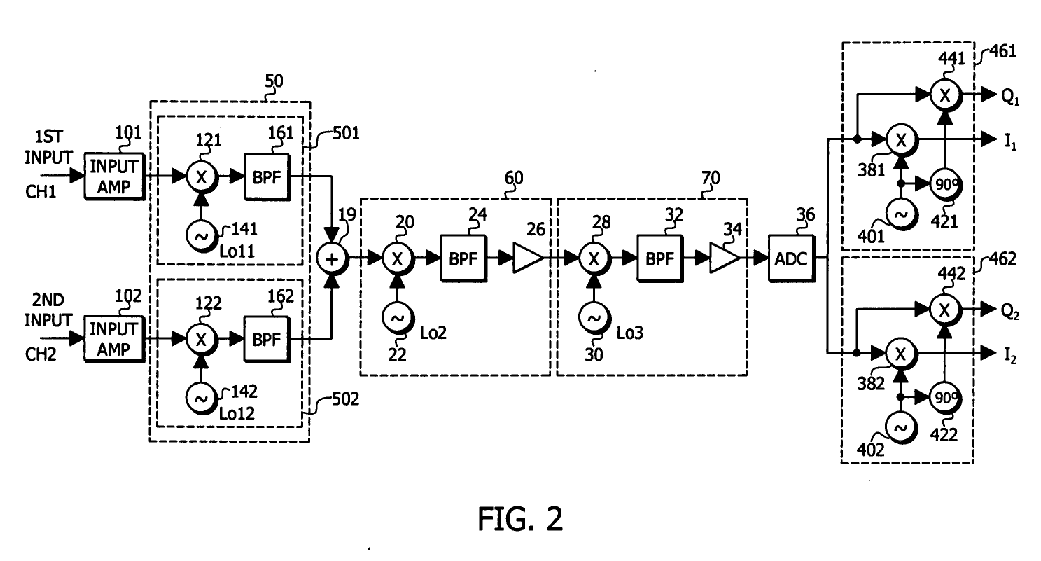

FIG. 2 is a block diagram of a preferred embodiment of a frequency converter according to the present invention. The frequency converter is coupled to and is controlled by a control means (not shown) as will be understood by one skilled in the art. The control means may comprise a microprocessor, memory, hard disk drive (HDD), etc. The HDD, or other storage mechanism, may store a control program. Like numerals in the figures indicate similar, or corresponding, blocks, functions, structures or elements.

In the embodiment according to the present invention, there are two paths in input amplification and first frequency conversion stage 50 but the two outputs are unified to one path. The first frequency conversion stage 50 has first and second frequency conversion paths 501 and 502. First and second input amplifiers 101 and 102 receive and provide first and second input signals to the respective mixers 121 and 122. The mixers 121 and 122 multiply the first and second input signals by predetermined signals from local oscillators 141 and 142. Band pass filters (BPFs) 161 and 162 preferably pass only desired frequencies of the outputs of the respective mixers 121 and 122. A combiner 19 adds the outputs of BPFs 161 and 162 while matching the impedance to unify the two channel signals.

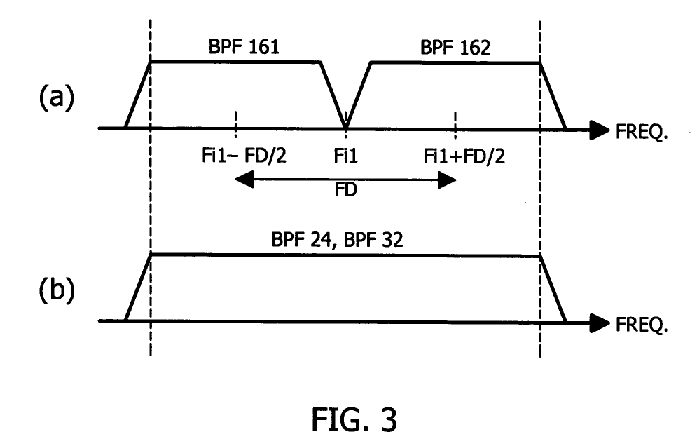

Oscillation frequencies Lo11 and Lo12 from local oscillators 141 and 142 are controlled to have a predetermined frequency difference FD between them, so that the first input signal is converted into a first IF fit in the upper half of a whole IF bandwidth and the second input signal is converted into a second IF fit in the lower half of the whole IF bandwidth. That is, the whole IF bandwidth is divided and used by them separately as illustrated in FIG. 3.

If a user sets the center frequencies of the first and second input signals to F1c and F2c, and an IF of the first frequency conversion stage is denoted as Fi1, the oscillation frequencies Lo11 and Lo12 of the local oscillators 141 and 142 may be described by the following equations 1 and 2:
Lo11=F1c+Fi1+FD/2
Lo12=F2c+Fi1−FD/2

Lets explain the relationship indicated by the equations 1 and 2 with reference to FIG. 3. Referring to FIG. 3 at (a), the first stage IF Fi1 and the frequency difference FD are selected to have values in such a way that the center frequencies of the BPFs 161 and 162 are Fi1+FD/2 and Fi1−FD/2, respectively. As shown in FIG. 3 at (b), the BPFs 24 and 32 are selected to have frequency bandwidths that include both of the BPFs 161 and 162 though frequencies of the BPFs 24 and 32 may be different. In other words, the frequency difference FD is decided depending on the performance of the BPFs.

Referring again to FIG. 2, frequency conversion stages 60 and 70 down-convert the output of the combiner 19, which includes two channel components. An analog to digital converter (ADC) 36 converts the output of the conversion stage 70 into digital data. As described, the present invention processes and digitizes the IF signal from the multi-channels by the same circuits following the combiner 19 to reduces timing and transmission characteristic differences between the signals of the different channels.

First and second digital IQ splitters 461 and 462 corresponding to the respective two input channels split the digital output signal of the ADC 36. The digital IQ splitters 461 and 462 can be implemented by DSP and have the respective virtual oscillators 401 and 402 of which output sine frequency data are controlled to have the frequency difference (FD) with respect to each other. The sine frequency data are multiplied by the digital output data from the ADC 36 as indicated by mixer blocks 381 and 381. Phase shifter blocks 421 and 422 shift the phase of the digital sine signals from the oscillators 401 and 402 by 90 degrees to produce digital Q signals by mixer blocks 441 and 442. The blocks indicate functions of the DSP and the processes can be done by calculation. The 10 splitters may be implemented as disclosed in U.S. Pat. No. 6,340,883 by Nara et al.

The described embodiment has two input channels as an example but other embodiments may have three or more channels. The frequency difference FD is not limited to a fixed value but may be controlled to have a variable value according to the bandwidth of input signals under test or a user-selected span. The ADC 36 may not be used and then analog IQ splitters in place of the digital IQ splitters 461 and 462 would be used to receive and split the analog output of the stage 70, which process is well known.

As described above, frequency conversion according to the present invention features less timing and characteristic differences between input signals. Increasing the number of the input channels only increases the number of the input signal paths at the first stage, but the following frequency conversion circuit can be the same, allowing increased number of input channels at low cost. Therefore, the frequency conversion according to the present invention is suitable for an application analyzing characteristics between a plurality of signals that are used for multi-path communication such as MIMO.

What is claimed is:

1. A frequency converter comprising:
a plurality of frequency conversion paths that receives a plurality of input signals to produce the respective IF signals of which center frequencies are controlled to have a predetermined frequency difference;
means for combining the IF signals from the frequency conversion paths into a combined IF signal;
means for frequency converting the combined IF signal to produce a frequency-converted combined IF signal; and
means for splitting the frequency-converted combined IF signal into IQ signal pairs corresponding to the input signals respectively.

2. The frequency converter recited in claim 1 further comprising means for digitizing the frequency-converted combined IF signal wherein the splitting means produces the IQ signal pairs by digital process.

3. The frequency converter recited in claim 1 wherein sine frequencies of the 10 splitters used for 10 split are controlled to have the predetermined frequency difference.

4. The frequency converter recited in claim 3 wherein the splitting means are implemented by digital signal processor.

5. A method for converting frequencies of a plurality of input signals comprising the steps of:
converting the input signals into IF signals respectively wherein the center frequencies of the IF signals are controlled to have a predetermined frequency difference;
combining the IF signals into a combined IF signal;
converting the frequency of the combined IF signal to produce a frequency-converted combined IF signal; and
splitting the frequency-converted combined IF signal into IQ signal pairs corresponding to the input signals respectively.

6. The method for converting the frequencies of the input signals as recited in claim 5 further comprising a step of digitizing the frequency-converted combined IF signal wherein the splitting step is done by digital process.

7. The method for converting the frequencies of the input signals as recited in claim 5 wherein sine frequencies corresponding to the respective IQ signal pairs used in the splitting step are controlled to have the predetermined difference each other.

8. A frequency converter comprising:
a plurality of frequency conversion paths that receives a plurality of input signals to produce the respective IF signals of which center frequencies are controlled to have a predetermined frequency difference;
a combiner having a plurality of inputs from the frequency conversion paths and a single output to provide a combined IF signal;
a frequency converter connected to the single output to receive the combined IF signal to produce a frequency-converted combined IF signal; and
a splitter connected to the frequency convert to split the frequency-converted combined IF signal into a plurality of IQ signal pairs corresponding to the plurality of input signals.

9. The frequency converter recited in claim 8 further comprising an analog-to-digital converter for receiving and digitizing the frequency-converted combined IF signal, and wherein the splitter produces the IQ signal pairs digitally.

10. The frequency converter recited in claim 8 wherein sine frequencies of the IQ splitters used for IQ split are controlled to have the predetermined frequency difference.

11. The frequency converter recited in claim 9 wherein the splitter is implemented by a digital signal processor.
